(19) United States
(12) Patent Application Publication
(10) Pub. No.: US 2006/0154082 A1
(43) Pub. Date: Jul. 13, 2006

(54) Flexible radiation curable compositions

(76) Inventors: Christopher Wayne Miller, Acworth, GA (US); Jo Am Arceneaux, Marietta, GA (US); Larisa Kagansky, Dacula, GA (US); Michael J Idacavage, Marietta, GA (US); Marcus Hutchins, Rockmart, GA (US); Morris Arthus Johnson, Sun Lakes, AZ (US)

Correspondence Address: WENDEROTH, LIND & PONACK, L.L.P., 2033 K STREET N. W., SUITE 800, WASHINGTON, DC, 20006-1021, US

(21) Appl. No.: 10/542,247

(22) PCT Filed: Jan. 21, 2004
(86) PCT No.: PCT/EP04/00452

§ 371 Date: Dec. 30, 2005

Related U.S. Application Data
(63) Continuation of application No. 10/355,194, filed on Jan. 31, 2003, now abandoned.

(51) Int. Cl. C08G 18/00; B32B 27/40

(52) U.S. Cl. 428/423.1; 525/920; 528/44

(57) ABSTRACT

Polymerizable compositions are described containing urethane (meth)acrylate oligomers and certain polymerizable monomers useful in thermoforming and in-mold decoration applications.

The invention relates to improved radiation curable compositions comprising radiation curable oligomer, radiation curable monomers, and various additives. Such types of compositions are useful for making radiation curable inks, coatings, and adhesives.

Radiation curable compositions are commonly used as inks, coatings, and adhesives. Advantages of the radiation curable compositions over conventional solvent-borne compositions include: speed of application and curing, decreased levels of VOC's (volatile organic compounds), reduced process energy, requirements, and spatial discretion in curing.

Radiation curable compositions that exhibit flexibility after cure are known in the art, and have been used for various applications including fiber-coating, thermoforming, in-mold-decoration IMD), and in-mold-coating (IMC) processes. Generally, the prior art in thermoformable radiation curable resins provides coatings and inks which exhibit flexibility, but which also exhibit the undesirable property of high surface tack (stickiness) after curing. High surface tack causes difficulties with handling the printed and/or thermoformed articles because stacking of tacky articles leads to sticking and transfer of inks/coatings to the backs of adjacent articles in the stacks. Methods to offset the high surface tack after curing are known and include: addition of significant amounts of inert fliers, dusting printed and/or thermoformed objects with powder prior to stacking, and insertion of intermediate films between printed and/or thermoformed objects prior to stacking. These methods typically partially or significantly compromise utility of the flexible resins by altering the rheology of the curable compositions, adding extra steps in the processing of the articles, and/or decreasing the flexibility and elongation at break of the cured inks and/or coating. Other radiation curable resins for inks and coatings shoving good flexibility with low surface tackiness typically do not show good adhesion to a range of polymeric substrates.

IMD and IMC processes are known and the bulk of the prior art in the field involves use of solvent-borne coatings or water-borne coatings with or without a tie-coat layer, which serves to increase adhesion between the cured ink/coating and the injected polycarbonate layer in the IMD laminates. As noted previously, solvent-borne coatings have the distinct disadvantage of releasing significant quantities of VOC's during processing.

Water-borne coatings are typically more environmentally friendly, though they require the use of significant energy expenditures to remove the water before they can be cured. Utilization of tie-coat layers in IMD processing is not preferred because it adds an extra step to the process.

WO 02/50186 A1 provides for a radiation curable coating or ink composition useful with or without solvent and without the use of a tie-coat layer in IMD processes. WO 02/50186 A1 specifically teaches that oligomers containing linear aliphatic or aromatic polycarbonate-based polyol residues in the oligomer backbones show benefits for adhesion in IMD applications, and that such oligomers may be optionally combined with oligomers of other functionality such as polyester and polyether to modify the flexibility and other characteristics of radiation curable compositions containing them. However, the invention of WO 02/50186 A1 requires the use of mostly polycarbonate-based radiation curable oligomers to generate adequate adhesion in the IMD articles, thereby limiting the range of oligomers, and the flexibilities of those oligomers, which may be used in IMD processes.

Hetero-atom functional cyclic- and acyclic radiation curable monomers are also known in the art, and certain examples of this class of materials have been recognized in several instances as exhibiting enhanced rates of curing as disclosed in U.S. Pat. No. 5,047,261 and U.S. Pat. No. 5,360,836. A mechanism to explain the surprising rapid polymerization rates is proposed in WO 02/42383 A1. Therein is taught the hypothesis that attachment of functional groups which have a calculated Boltzman average dipole moment of greater than 3.5 Debye to acrylate groups produces monomers that show unexpectedly efficient photopolymerization kinetics leading to very high rates of curing. The inventors of WO 02/42383 further teach that inclusion of such monomers in ration curable compositions allows surprising increases in the rates of curing of those compositions and that such rapid rates of curing are useful in coating of glass fibers in processing of fiber optic cabling. The active mechanisms and their relative contributions to the rapid rates of polymerization of these types of monomers are under investigation by various academic and industrial researchers, and a complete understanding of the causalities leading to the enhanced rates has yet to be presented.

The objective of the present invention is to provide radiation curable compositions which demonstrate the following enabling characteristics in combination: high flexibility, high adhesion to polymeric substrates, low post cure surface tackiness, good thermal stability, and low shrinkage upon cure, such as are useful and necessary for preparation of substantially solvent-free radiation curable inks and coatings for thermoforming applications and other applications where such properties in combination are useful, with the additional essential criteria of having good adhesion to injection-molded polycarbonate and/or other thermoplastic resins in laminate structures produced via In-Mold-Decoration or In-Mold-Coating-type processes.

The objective has been attained using radiation curable compositions comprising urethane (meth)acrylate oligomers with high flexibility and high percentage elongation at break in particular combination with certain radiation curable hetero-atom containing monomers. Additionally, diluents, radical-generating initiators, and various additives may optionally be employed.

The present invention therefore relates to a polymerizable coating composition comprising:

a) about 5-85% by weight of a urethane (meth)acrylate oligomer as depicted below, or a mixture of such oligomers, wherein the polymerizable oligomer or oligomer mixture shows percent elongation at break greater than about 100% and a number average molecular weight of about 1.000-20.000 g/mol, said oligomer having the formula:
CH₂═CH(R1)-COO—R2-OCONH—R3-NHCOO—[Z—OCONH—R3-NHCO]ₙ—OR2-OCO—CH(R1)=CH₂
where:

R1=H, CH₃

R2=CH₂CH₂, CH₂CH(CH₃)CH₂CH₂CH₂O[CO(CH₂)₅)_{q}, CH₂CH₂CH₂CH₂. CH₂CHCH₃, CH₂CH₂CH₂, CH₂CH₂CH₂CH₂CH₂

n 1 to about 20

q=1 to about 20

R3=aliphatic, cycloaliphatic, heterocyclic, or aromatic radical with molecular weight about 25-10,000 g/mol

Z=moiety from one or more of: polyesters, polyethers, polyglycols, polycarbonates, polyurethanes, polyolefins; having a number average molecular weight of about 25-10,000 g/mol, wherein said Z moieties have the following formulae:
polyesters: -[A-OCO—COO]ₘ-A- or —[E-COO]ₘ-D-[OCO-E]ₘ-
polyethers/polyglycols: -A-[G-O]ₘ-G- or -G-[O-G]ₘ-O-A-O-[G-O]ₘ-G- or -A-
polycarbonates: -J-[COO-J]ₘ-
polyurethanes: -L-[OCON-Q-NCOO-]ₘ-
polyolefins: -Q-[R]ₘ-Q-

where:

A=linear, branched, or cyclic aliphatic or aromatic radical with a molecular weight of about 14 g/mol-1,000 g/mol based upon C and H, and optionally containing N, O, S, or Si

B=linear, branched, or cyclic aliphatic or aromatic radical with a molecular weight of about 14 g/mol-1,000 g/mol based upon C and H, and optionally containing N, O, S, or Si

D=linear, branched, or cyclic aliphatic or aromatic radical with a molecular weight of about 14 g/mol-1,000 g/mol based upon C and H, and optionally containing N, O, S, or Si

E=linear, branched, or cyclic aliphatic or aromatic radical with a molecular weight of about 14 g/mol-1,000 g/mol based upon C and H, and optionally containing N, O, S, or Si

G=linear, branched, or cyclic aliphatic radical with a molecular weight of about 14 g/mol-1,000 g/mol based upon C and H, and optionally containing N, O, S, or

J=linear, branched, or cyclic aliphatic or aromatic radical with a molecular weight of about 14 g/mol-2,000 g/mol based upon C and H, and optionally containing N, O, S, or Si

L=linear, branched, or cyclic aliphatic or aromatic radical with a molecular weight of about 14 g/mol-2,000 g/mol based upon C and H, and optionally containing N, O, S or Si

Q=linear, branched, or cyclic aliphatic or aromatic radical with a molecular weight of about 14 g/mol-2,000 g/mol based upon C and H, and optionally containing N, O, S, or Si

R=linear, branched, or cyclic aliphatic or aromatic radical with a molecular weight of about 14 g/mol-4.000 g/mol based upon C and H, and optionally containing N, O, S, or St

m=1 to about 1,000, and

b, about 0.1-50% by weight of a polymerizable diluting monomer or mixture thereof selected from the group consisting of: (meth)acrylate, (meth)acrylaxide, vinylether, vinylester, N-vinylamide, propenylether, malelmide, maleate, or fumarate, and

c, about 0.1-50% by weight of additional polymerizable oligomer, and

d, about 0-20% by weight of a compound or mixture of such compounds which may generate radicals capable of initiating the curing reactions of the curable composition and which may be activated by one or more methods selected from the group consisting of exposure to actinic radiation, exposure to ionizing radiation, exposure to heat, and

e, about 0-25% by weight of other additives selected from the group consisting of amines, defoamers, flow aids, fillers, surfactants, acrylic polymers and copolymers, and adhesion promoters, and

f, about 0-5% by weight of a fluorinated compatibilizer; and

g, about 0.5-60% by weight of a polymerizable monomer component composed of one or more compounds selected from formulae 1-1 wherein the compound exhibit a maximum rate of homopolymerization within the range 0.01-7 molL⁻¹ s⁻¹, as measured by RTFTIR at 25° C. using 25 mW/cm² on-sample light intensity from the full are of a medium pressure mercury lamp to cure 10 μm-thick samples containing 5% by weight Darocur 1173 as photoinitiator, in a salt crystal/polypropylene laminate, such that the selected compounds will exhibit slow or inefficient polymerization and/or copolymerization properties such that the selected compounds remain in part or in whole unpolymerized in the cured coating, 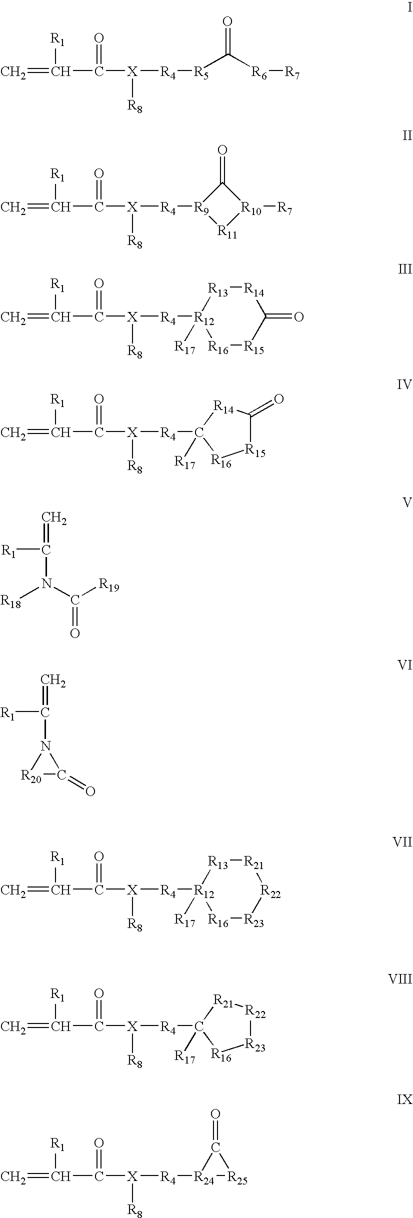
where:

R1=H, CH₃

R4=aliphatic or aromatic radical of about 15-100 g/mol molecular weight containing C, H, and optionally one or more of N, O, S, Si

R5=O, N, S

R6=O, N, S

R7=H, or aliphatic or aromatic radical of about 15-1000 g/mol molecular weight containing C, H, and optionally one or more of N, O, S, Si

R8=absent when X=O; H, or aliphatic or aromatic radical of about 15-1000 g/mol molecular weight containing C. H, and optionally one or more of N, O, S, Si when X═N

R9=N

R10=N

R11=aliphatic or aromatic radical of about 15-1000 g/mol molecular weight containing C, H, and optionally one or more of N, O, S, Si

R12=O, N

R13=aliphatic radical having about 1-10 carbon atoms optionally containing N, O or S

R14=O, NH, S

R15=O, NH, S

R16=aliphatic radical having about 1-10 carbon atoms optionally containing N, O, or S

R17=H, or aliphatic or aromatic radical of about 15-1000 g/mol molecular weight containing C, H, and optionally one or more of N, O, S, Si

R18=H, or aliphatic or aromatic radical with molecular weight about 15-1,000 g/mol

R19=H, or aliphatic or aromatic radical with molecular weight about 15-1,000 g/mol

R20=branched or straight-chained aliphatic, aromatic, or heterocyclic radical with molecular weight of about 14-1,000 g/mol.

R21=O, S, NR17

R22=CHR17

R23=O, S, NR17

R24=N

R25=aliphatic radical having about 1-10 carbon atoms optionally containing N, O, or S.

The compositions yield cured inks, coatings, and/or adhesives which exhibit in combination the following essential performance characteristics: high flexibility, high adhesion to various polymeric substrates, little or no post-cure surface tackiness, low shrinkage upon cure, good thermal stability, and good adhesion to thermoplastics injection-molded onto the surface of the partially or fully cured ink, coating, and/or adhesive.

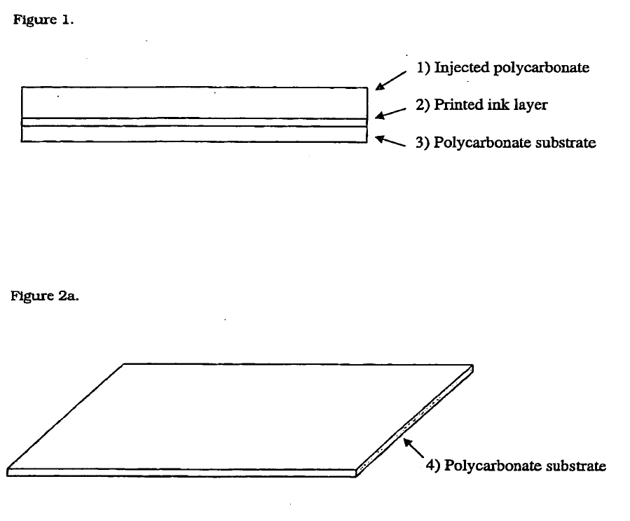

FIG. 1 depicts an IMD laminated article of the present invention wherein the layer of injected polycarbonate is labeled 1), the printed and cured ink layer is labeled 2), and the polycarbonate substrate is labeled 3).

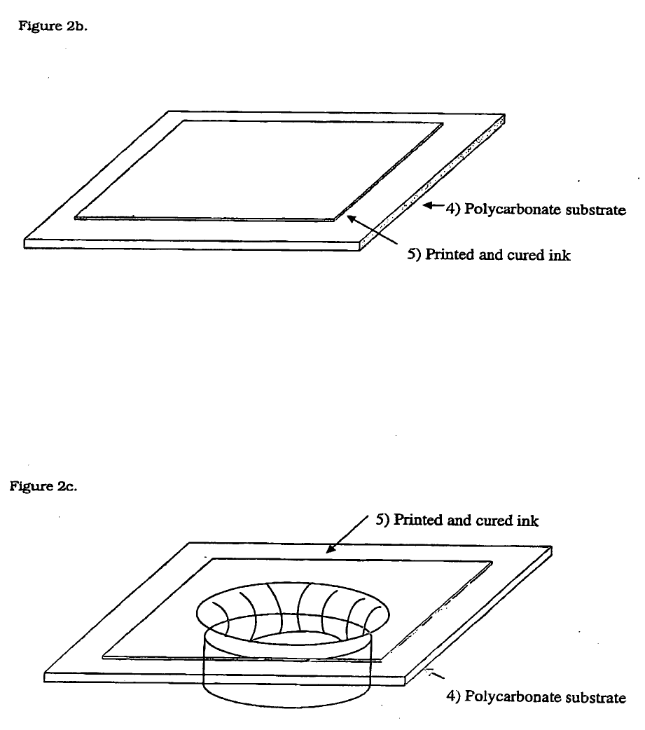

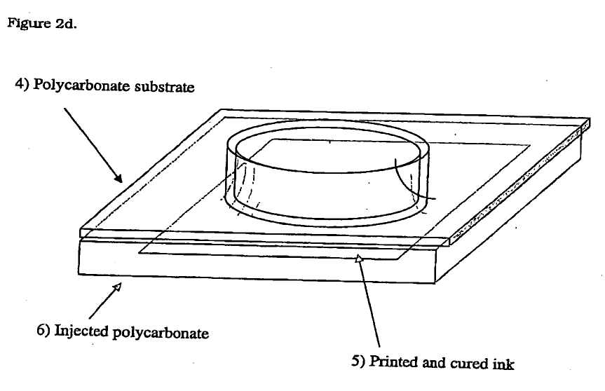

FIG. 2a depicts a one-layer polycarbonate substrate wherein the layer is labeled 4).

FIG. 2b depicts a polycarbonate substrate printed with a radiation curable ink of the present invention wherein the polycarbonate substrate is labeled 4) and the ink layer is labeled 5).

FIG. 2c depicts a thermoformed printed substrate in accordance with the present invention wherein the polycarbonate substrate is labeled 4) and the ink layer is labeled 5).

FIG. 2d depicts an injection molded thermoformed printed article of the present invention produced via the IMD process wherein the polycarbonate substrate is labeled 4), the ink layer is labeled 5), and the injected polycarbonate layer is labeled 6).

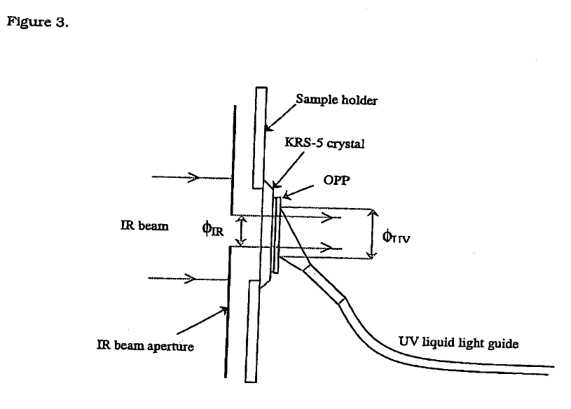

FIG. 3 depicts the experimental sample setup for the kinetic measurements made using Real mine Fourier Transform Infrared Spectroscopy.

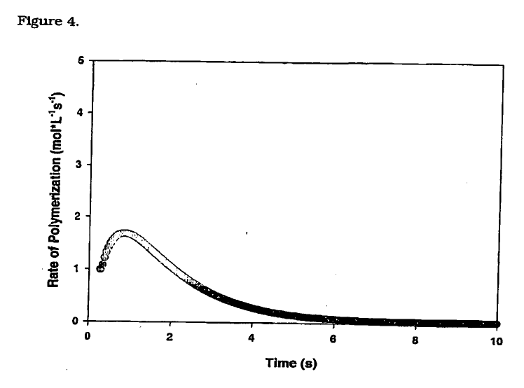

FIG. 4 depicts a plot of rate of polymerization versus polymerization time calculated for a Compound 1 (g) based upon conversion data from Real Time Fourier Transform Infrared Spectroscopy kinetic experiments.

The improvement in performance characteristics of the polymerizable compositions of the present invention over the prior art lies in the attainment, in combination, of useful and essential properties and performance characteristics including the following:
a) controlled flexibility and elongation at break, as afforded by design of the base oligomers which exhibit elongation at break greater than 100%, typically greater than about 300%, and optionally as high as about 900%.
b) high adhesion to polymeric substrates including for example: polyethylene-terephthalate polyethylene-terephthalate-g (PET-g), polyvinylchloride (PVC), polystyrene (PS), acrylic, and in particular, polycarbonate (PC),
c) adhesion to thermoplastics injection molded onto the surface of the ink, coating, or adhesive comprised of the inventive composition during IMD and/or IMC processes, including for example: polycarbonate-based thermoplastics, and acrylic thermoplastics,
d) thermal stability and temperature resistance to afford stability at processing temperatures used during thermoforming and injection-molding stages of IMD and/or IMC processes including for example: resistance to thermal degradation during pre-heating, thermoforming, and injection molding as well as resistance to wash-out by injected thermoplastic resins during IMD and/or IMC processes.
e) little or no post-cure surface tackiness at temperatures from room temperature up to about 65° C. to allow stacking of printed or coated articles without cooling and without use of covering layers or powders, and
f) low shrinkage upon cure as afforded by the base oligomers typified in the inventive examples, which exhibit shrinkage upon cure of less than about 2%, and typically less than about 1%.

It has been found that the oligomer/monomer combination upon which the radiation curable compositions are built affects useful properties a)-f, and for example, that enhancing property a) using oligomers known in the art typically had detrimental effect on property c). It has been found that by the appropriate choice of constituent components of the radiation curable oligomers, and by particular combination of those constituent components, these performance characteristics could be obtained in combination for use In substantially solvent-free radiation curable coatings, inks, and adhesives. In meeting the target performances of the objective, it has further been found that particular combination of compositions providing for properties a), b), and d)-f), with certain particular slow-polymerizing hetero-atom containing monomer components provides useful and necessary property c) while enhancing property b).

The following is an explanation of the typical operations used in in-mold-decoration and thermoforming processes.

A typical thermoforming processes includes generally the following steps:

1) A sheet (like an overhead transparency) of polymer (polycarbonate, PET, polystyrene, PVC, etc.) as depicted in FIG. 2a is printed with a graphic design by a screen printing process.

2) The printed ink is cured (that is, polymerized, or otherwise hardened) by passing the print under ultraviolet light on a conveyor belt system yielding a printed substrate as depicted in FIG. 2b.

3) Steps 1) and 2) are repeated for up to 56 colors/layers.

4) The printed sheets are then optionally stacked and transported to another location for forming.

5) The printed sheets are clamped into a thermoforming machine and heated by infrared or other radiant heat source, with the temperature and time of the heating operation dependent upon the type of substrate.

6) When the sheet is sufficiently soft, a mold is forcefully pressed into the printed side (or optionally into the unprinted side) of the sheet and vacuum is applied to wrap the sheet tightly onto the mold form.

7) Cooling air is applied to harden the piece, and the formed object is removed from the thermoforming machine resulting in an object as depicted in FIG. 2c.

8) The formed part is then trimmed to the final shape and stored prior to assembly into the finished product (bicycle helmet, soft drink machine cover, sign, etc.).

Hence, for steps 1-3, the ink should exhibit excellent adhesion to the polymer substrate and must show good intercoat adhesion to allow multi-layer printing. For step 4, the printed cured inks should have very low surface tack (stickiness) so that prints stacked on top of each other at elevated temperature and pressure do not stick to each other. For steps 56, the ink should exhibit reasonable resistance to heat (up to about 180° C.). For step 6, the ink should exhibit excellent flexibility and elongation to allow the substrate and ink to be stretched to draw ratios (depth: width ratio) as high as about 8:1. For the finished product, the ink should exhibit reasonable scratch resistance, and maintain excellent adhesion to the substrate.

A typical In-Mold-Decoration process comprises generally the following steps:

1) Steps 1-8 of the thermoforming process are completed using polycarbonate as the substrate (typically) resulting in an object as depicted in FIG. 2c.

2) The thermoformed part is then placed into a heated mold on an injection-molding machine.

3) The mold is then clamped shut and hot (about 275-300° C.) molten polycarbonate is injected directly onto the ink or coating surface, flowing across the face of the ink or coating and filling the mold.

4) The injected polycarbonate cools enough to solidify, and the part is removed from the mold resulting in an object as depicted in FIG. 2d.

5) The laminate part is then trimmed to the final shape and stored for assembly into the final product (cellular phone cover, automobile fascia, hockey helmet, etc.).

Hence, for Step 1 requirements of the thermoforming process apply. For Steps 2-3 the ink must have good temperature resistance and not be washed away from the printed substrate by the hot molten polycarbonate as it spreads across the ink surface. For Step 4, the ink must have good adhesion to the injected polycarbonate layer, or the laminate will fall apart.

Radiation curable compositions were produced with components from among the categories: radiation curable urethane (meth)acrylate oligomer, radiation curable monomers and diluents, radical-generating photoinitiators, and additives. Constituents in those categories are along with the weight percentages of each category useful in radiation curable compositions of the present invention are set forth below. All percentages are by weight based upon the total weight of the composition. All molecular weights are given as number-average molecular weight in units of grams per mole.

Radiation Curable Urethane (Meth)acrylate Oligomer (a) is generally defined as an acrylate and/or methacrylate functional urethane oligomer with one to four polymerizable acrylate and/or methacrylate groups, and preferably with two polymerizable acrylate and/or methacrylate groups. The molecular weight range of the oligomer is about 1,000-20,000 g/mol, preferably about 2,500-15,000 g/mol, and most preferably about 4,000-10,000 g/mol. The oligomer has an elongation at break of greater than about 100%, as measured by tensile testing of a radiation-cured thin free-film of the oligomer, and preferably greater than about 300% elongation at break. The urethane (meth)acrylate has a general structure
CH₂═CH(R1)-COO—R2-CONH—R3-NHCOO-[Z-OCONH—R3-NHCO]ₙ-O—R2-OCO—CH(R1)=CH₂
where:

R1=H, CH₃

R2=CH_{2 CH}₂, CH₂CH(CH₃)CH₂, CH₂CH₂O[CO(CH₂)₅]_{q}, CH₂CH₂CH₂CH₂, CH₂CHCH₃, CH₂CH₂CH₂, CH₂CH₂CH₂CH₂CH₂

n=1 to about 20

q=1 to about 20

R3=aliphatic, cycloaliphatic, heterocyclic, or aromatic radical with molecular weight about 25-10,000 g/mol

Z=moiety from one or more of: polyesters, polyethers, polyglycols, polycarbonates, polyurethanes, polyolefins; having a number average molecular weight of about 25-10,000 g/mol, wherein said Z moieties have the following formulae:
polyesters: -[A-OCO—B—COO]ₘ-A- or -[E-COO]ₘ-D-[OCO-E]ₘ-
polyethers/polygycols: -A-[G-O]ₘ-G- or -G-[O-G]ₘ-O-A-O-[G-O]ₘ-G- or -A-
polycarbonates: -J-[OCOO-J]ₘ-
polyurethanes: -J-[OCON-Q-NCOO-L]ₘ-
polyolefins: -Q[R]ₘ-Q-

where:

A=linear, branched, or cyclic aliphatic or aromatic radical with a molecular weight of about 14 g/mol-1,000 g/mol based upon C and H, and optionally containing N, O, S, or Si

B=linear, branched, or cyclic aliphatic or aromatic radical with a molecular weight of about 14 g/mol-1,000 g/mol based upon C and H, and optionally containing N, O, S, or Si

D=linear, branched, or cyclic aliphatic or aromatic radical with a molecular weight of about 14 g/mol-1,000 g/mol based upon C and H, and optionally containing N, O, S, or Si

E=linear, branched, or cyclic aliphatic or aromatic radical with a molecular weight of about 14 g/mol-1,000 g/mol based upon C and H, and optionally containing N, O, S, or Si

G=linear, branched, or cyclic aliphatic radical with a molecular weight of about 14 g/mol-1,000 g/mol based upon C and H, and optionally containing N, O, S, or Si

J=linear, branched, or cyclic aliphatic or aromatic radical with a molecular weight of about 14 g/mol-2,000 g/mol based upon C and H, and optionally containing N, O, S, or Si

L=linear, branched, or cyclic aliphatic or aromatic radical with a molecular weight of about 14 g/mol-2,000 g/mol based upon C and H, and optionally containing N, O, S, or Si

Q=linear, branched, or cyclic aliphatic or aromatic radical with a molecular weight of about 14 g/mol-2,000 g/mol based upon C and H, and optionally containing N, O, S, or Si

R=linear, branched, or cyclic aliphatic or aromatic radical with a molecular weight of about 14 g/mol-4,000 g/mol based upon C and H, and optionally containing N, O, S, or Si

m=1 to about 1,000.

The oligomer may be prepared by reacting a hydroxy-functional (meth)acrylate component and one or more polyols with one or more isocyanate functional compounds, as defined following, via standard synthetic methods. Examples of components useful in the synthesis of the radiation curable oligomers are given following.

Hydroxy-Functional (Meth)acrylate Component: polymerizable (meth)acrylate functionality is incorporated into the said oligomer by reaction of the hydroxy functional group of hydroxy functional (meth)acrylate compound, with molecular weight of about 100 g/mol-1,500 g/mol, with an isocyanate functional compound as defined following. Examples of the hydroxy-functional (meth)acrylate component used to synthesize the oligomer may include: 2-hydroxylethylacrylate (2-HEMA) 2-hydroxypropylacrylate (2-HPA), hydroxybutylacrylate (HBA), 2-hydroxyethylmethacrylate (2-HEMA), 2-hydroxypropylmethacrylate (2-HPMA), hydroxybutylmethacrylate (HBMA), and 2-[(1-oxo-2-propenyl)oxy]ethylester, and alkoxylated variants of the same. The preferred embodiments of the oligomer include examples synthesized using 2-hydroxylethylacrylate and/or 2-[(1-oxo-2-propenyl)oxy]ethylester.

Polyol Component: examples of the polyol used to synthesize the oligomer include hydroxy-functional oligomers, homopolymers, and/or copolymers from among the following types: aliphatic and/or aromatic polyester, aliphatic and/or aromatic polyether, aliphatic and/or aromatic polycarbonate, aliphatic and/or aromatic polyurethane, and polyolefin. Various polyol types may be incorporated into the oligomer portion of the composition by blending oligomers made with different Individual polyol types and/or by making oligomers that include two or more polyols types in a single oligomer backbone. The polyols may be within the molecular weight range about 25-10,000 g/mol, and preferably in the range about 1000-4000 g/mol.

Examples of materials that may comprise a polyester polyol backbone include, but are not limited to, the following polyols: butanediol, propanediol, ethyleneglycol, diethyleneglycol, hexanediol, propyleneglycol, dimer-diol, cyclohexanedimethanol, 2-methylpropanediol, and the like; and include, but are not limited to, the following dibasic acids: adipic acid, phthalic acid, isophthalic acid, terephthalic acid, dodecandioic acid, poly(epsilon-caprolactone), dimer acid, fumaric acid, succinic acid, and the like. Polyester polyols may also optionally be prepared as poly-lactones such as poly(epsilon-caprolactone) by ring-opening polymerization of epsilon-caprolactone, or optionally by copolymerization of epsilon-caprolactone with one or more of the polyols mentioned previously.

Examples of materials that may comprise a polyether polyol homopolymer or copolymer backbone include, but are not limited to, the following: poly(ethylene glycol), poly(propylene glycol), poly(tetrahydrofuran), poly(3-methyl-tetrahydrofuran), poly(bisphenol-A-glycidyiether), poly(hexamethyleneglycol), and the like. Hydroxy functional polyols prepared by ring-opening homopolymerization or copolymerization of cyclic ethers such as tetrahydrofuran, ethylene oxide, cyclohexene oxide, and the like may also be used.

Examples of materials that may comprise a polycarbonate polyol backbone include, but are not limited to the following: poly(hexanediol carbonate), poly(butanediol carbonate), poly(ethyleneglycol carbonate), poly(bisphenol-A carbonate), poly(tetrahydrofuran) carbonate, poly(nonanediol carbonate), poly (3-methyl-1,5-pentamethylene carbonate), and the like.

Examples of materials that may comprise a polyurethane polyol backbone include, but are not limited to the following polyols: butanediol, hexanediol, ethyleneglycol, diethyleneglycol, and the like; and may include, but are not limited to, the following isocyanates: hexamethylenediisocyanate, isophorone-diisocyanate, bis(4-isocyanatocyclohexyl)methane, toluene-diisocyanate, diphenylmethane-4,4′-diisocyanate, trimethylhexamethylene diisocyanate, tetramethyl-m-xylene diisocyanate, and the like, as well as isocyanate functional biurets, allophonates, and isocyanurates of the previously listed isocyanates.

A particularly useful combination of polyols in the oligomer synthesis is mixed aliphatic/aromatic polyester polyols with polyether polyol wherein such combinations can be derived by mixing individually prepared oligomers or by using the polyols in combination in an individual extended oligomer.

Isocyanate Component: the isocyanate functional compound used to synthesize the oligomer may include, but are not limited to, one or more of the following examples of difunctional aromatic and/or aliphatic isocyanates: hexamethylene-diisocyanate (HMDI), isophorone-diisocyanate (IPDI), bis(4-isocyanatocyclohexyl)methane, toluene-diisocyanate (TDI), diphenylmethane-4,4′-diisocyanate (MDI), trimethylhexamethylene diisocyanate, tetramethyl-m-xylene diisocyanate. Particularly useful examples of isocyanates include hexamethylene-diisocyanate (HMDI) and isophorone-diisocyanate (IPDI), which engender flexibility in the radiation curable oligomer. Optionally, isocyanate functional biurets, allophonates, and isocyanurates of the previously listed or similar isocyanates may be used.

Polymerizable diluting monomers or mixtures thereof (b) are useful for enhancing the cure speed of formulations, because highly flexible high molecular weight (meth)acrylate oligomer formulations of the types described in this invention often may exhibit a relatively low cure speed due to their relatively low concentration of polymerizable groups. Such monomers are also useful for adjusting rheology and viscosity, modifying the post-cure scratch and abrasion resistance, modifying the pre-cure and post-cure adhesion characteristics of the radiation curable compositions on various substrates, moping the chemical resistance, and modifying the post-cure flexibility of the radiation curable compositions. Furthermore, certain types of monomers, for example maleimides and vinylesters, have been demonstrated in the literature to function as copolymerizable photoinitiators as well as monomers, with useful effects on cure speed and quantities of residual extractables. For the formulations of the overall objective, radiation curable monomers and diluents may be selected from among the group: (meth)acrylate. N-vinylamide, vinylether, vinylester, maleimide, propenylether, (meth)acrylamide, maleate and furnarate.

Incorporation of additional polymerizable oligomer (c) in the composition of the invention can be of benefit to modify the post-cure tensile properties, post-cure hardness and impact resistance, post-cure scratch and abrasion resistance, pre-cure and post-cure chemical resistance, and pre-cure rheology and viscosity of those compositions. Useful oligomers may be selected from among the following types: polyester (meth)acrylate, urethane (meth)acrylate, polyester (meth)acrylamide, urethane (meth)acrylamide, vinylether functionalized oligomers, N-vinylamide functionalized oligomers, vinylester functionalized oligomers, maleimide functionalized oligomers, propenylether functionalized oligomers, and urea (meth)acrylate.

The compositions of the present invention may be polymerized or cured by exposure to heat after addition of a thermally-activated radical-producing initiator compound, by direct exposure to actinic and/or ionizing radiation without addition of an initiator compound, and/or preferably by exposure to actinic and/or ionizing radiation after addition of chemical species capable of generating radicals upon exposure to actinic and/or ionizing radiation. The compositions according to the invention comprise 0 to 20% by weight of a compound or a mixture of such compounds which may generate radicals capable of initiating the curing reactions of the curable composition and which may be activated by one or more methods selected from the group consisting of exposure to actinic and/or ionizing radiation or exposure to heat. The preferred embodiments of the compositions of the overall objective of the present invention include radical-generating photoinitiator compounds selected from the group: hydrogen-abstraction photoinitiators, cleavage photoinitiators, maleimide-type photoinitiators, and radical-generating cationic photoinitiators, and are cured by exposure to actinic radiation.

Various additives (e) may optionally be included in the inventive composition, as may be useful for preparing radiation curable compositions for inks and/or coatings, such as amines, defoamers, flow aids, fillers, surfactants, acrylic polymers and copolymers, and adhesion promoters. Examples of particularly useful types of additives include, but are not limited to, the following: acylated and/or non-acrylated amine synergists, fillers, defoamers, flow agents, pigments, dyes, pigment wetting agents, surfactants, dispersants, matting agents, acrylic copolymers, nano-particulate inorganic or organic solids, and non-polymerizable diluents.

The composition may comprise from 0 to 5% by weight of fluorinated compatibilizer (f). Fluorinated surfactants, oligomers and polymers are known in the art to be useful in preparing and compatibilizing polymer/polymer blends particularly during melt-extrusion processing. It has been found in the present invention that some fluoropolymer additives provided synergistic benefits for adhesion when combined in radiation curable compositions with the oligomers and monomers described above. The use of the fluoropolymer additives is not necessary to attain the useful combination of benefits of the invention, but may enhance adhesion in the IMD and other processes. It is postulated that the fluorinated oligomers and/or polymers affect the adhesion benefits by improving wetting of the polymer substrates by the curable composition and by improving wetting of the cured coating or ink composition by the injected thermoplastic during IMD processes. Examples of fluoropolymer additives that are particularly useful in the particular objective of the present invention include: Fluorad™ FC-4430 (3M™ Corporation) and Zonyl® FSG (Dupont Corporation).

The composition according to the present invention comprises from 0.5 to 60% by weight of polymerizable monomer component (g). Generally, radiation polymerizable monomers useful to gain adhesion to the injected polycarbonate layer in IMD and IMD laminated articles where the polycarbonate is injected directly onto the cured ink or cured coating surface are selected from those of formula (I) to (IX). 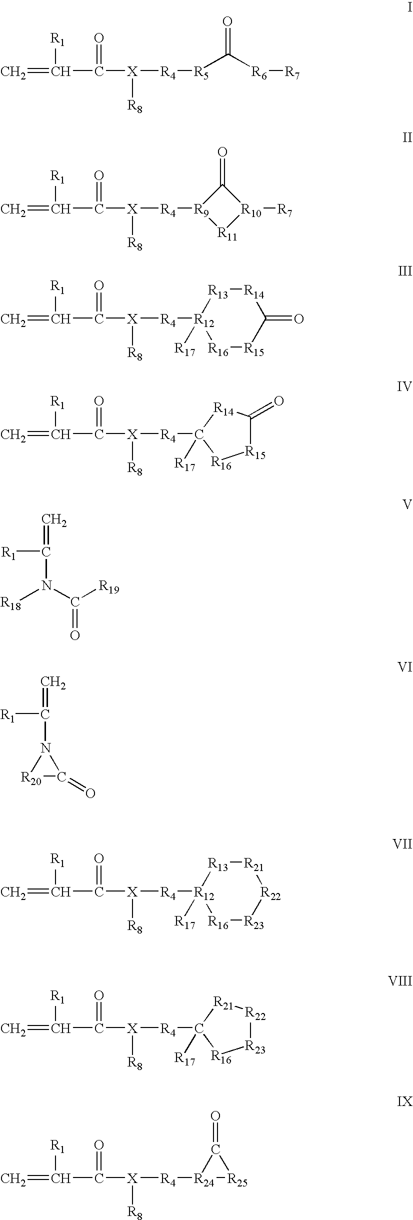
where:

R1=H, CH₃

X═O, N

R4=aliphatic or aromatic radical of about 15-1000 g/mol molecular weight containing C, H, and optionally one or more of N, O, S, Si

R5=O, N, S

R6=O, N, S

R7=H, or aliphatic or aromatic radical of about 15-1000 g/mol molecular weight containing C, H, and optionally one or more of N, O, S, Si

R8=absent when X-0; H, or aliphatic or aromatic radical of about 15-1000 g/mol molecular weight containing C, H, and optionally one or more of N, O, S, Si when X═N

R9=N

R10=N

R11=aliphatic or aromatic radical of about 15-1000 g/mol molecular weight containing C, H, and optionally one or more of N, S, Si

R12=O, N

R13=aliphatic radical of about C1-C10 length optionally containing N, O, or S

R14=O, NH, S

R15=O, NH, S

R16=aliphatic radical of about C1-C10 length optionally containing N, O, or S

R17=H, or aliphatic or aromatic radical of about 15-1000 g/mol molecular weight containing C, H, and optionally one or more of N, O, Si

R18=H, or aliphatic or aromatic radical with molecular weight about 15-1,000 g/mol

R19=H, or aliphatic or aromatic radical with molecular weight about 15-1,000 g/mol

R20=branched or straight-chained aliphatic, aromatic, or heterocyclic radical with molecular weight about 14-1,000 g/mol.

R21=O, S, NR17

R22=CHR17

R23=O, S, NR17

R24=N

R25=aliphatic radical of about C1-C10 length optionally containing N, O, or S

Previous publications in the art (U.S. Pat. No. 5,047,261, U.S. Pat. No. 5,360,836, WO 02/42383 A1) have demonstrated that a number of examples of (meth)acrylate monomers with hetero-atom functionality in linear and/or cyclic configurations exhibit particular utility due to highly enhanced rates of cure afforded by the monomers alone or in combination with other components in radiation curable compositions. In the present invention, it has been found that examples of (meth)acrylate monomers with hetero-atom functionality in linear and/or cyclic configurations which, in contrast to the claimed utility for examples in the previous patented art, show moderate or slow cure speeds, alone or in combination with other radiation curable components, offer surprising benefits for adhesion in IMD laminate articles. Specifically, examples of the heterocylic (meth)acrylate compounds that demonstrate the particular utility of enhanced rapid cure rates do not offer the adhesion benefits in IMD laminate articles observed with the slower curing examples. Additionally, N-vinyl functional amides have also been found in the present invention to offer surprising benefit for adhesion in IMD laminate articles.

In furtherance of the description of monomers which exhibit the unexpected adhesion benefit in ink, coating, and adhesive compositions utilized in IMD and IMC laminates, a series of free-radically polymerizable monomers with varying rates of homopolymerization were examined in comparison to the effects those monomers had on adhesion between a printed polycarbonate substrate and the injected polycarbonate layer in IMD laminate structures. In contrast to the afore-cited patent literature which claimed novel benefit due to very rapid cure speeds for compounds based upon measured or calculated dielectric constants resulting from structural and composition factors, our studies unexpectedly indicated that hetero-atom monomers exhibiting rapid rates of polymerization did not provide adhesion benefit in inks used for MD laminates, but rather that hetero-atom monomers exhibiting slow rates of homopolymerization gave significant enabling adhesion benefit in inks for IMD and IMC applications.

Rates of homopolymerisation of polymerisable monomer component (g) are evaluated via Real-Time Fourier Transform Infrared Spectroscopy (RTFTIR) using the experimental conditions described following and utilizing apparatus illustrated in FIG. 3. The infrared spectra were recorded in real-time using a Perkin-Elmer Spectrum GX FTIR spectrometer equipped with a TGS detector. Data were acquired and processed using commercially available software (TimeBase. Perkin Elmer). Full arc ultraviolet (UV) radiation from a Philips 400 W medium-pressure mercury lamp was introduced into the sample chamber through a flyable light guide. The light source (Flexicure, Macam) enabled synchronization between UV irradiation and infrared (IR) spectra recording and allowed timed exposures. The light guide was positioned 10 mm from the sample surface and tilted at an angle of 45° to avoid blocking the path of the IR beam. An IR beam aperture was used to ensure total UV radiation coverage of the sample area probed by the IR beam (ØIR<ØUV, see FIG. 3). A UV103 Macam radiometer equipped with a filter (UVA Cos-113) was used to measure the UV-A intensity at the sample position. Typical intensity values were 25 mW cm⁻². Conversions of the acrylate double bonds were followed via the decay of the absorption band of the C═CH—H6out-of-plane stretching mode at 809 cm⁻¹ by integration of the peak areas. Scan speeds of 20 spectra per second, at a resolution of 16 cm⁻¹, were found to be sufficient to obtain well-defined conversion profiles. Conversion versus time data were converted into rate versus time by taking the numerical 3-point average first derivative of the conversion plot and multiplying by the molar volume. Samples contained 5% Darocur 1173 (Ciba Specialty Chemicals Corporation) as photoinitiator. For sample preparation, the formulations were deposited onto a KRS-5 crystal with the aid of a calibrated bar coater. 10 μm-thick samples were sandwiched between the KRS-5 crystal and an oriented polypropylene sheet. This laminate was then placed on a standard sample holder for transmission measurements and inserted into the FTIR sample chamber. All experiments were performed at room temperature.

FIG. 4 provides a plot of rate in moles per liter per second versus time for Compound 1 ((2-Oxo-1,3-dioxolan-4-yl)methyl methacrylate). As is readily apparent, the rate of polymerization of Compound 1 is low; its maximum rate of polymerization is estimated at only 1.7 molL⁻¹ s⁻¹ under the polymerization conditions described above.

N-vinylpyrrolidinone (NVP) has been shown in the literature to have a very low efficiency of homopolymerization, with rates as low as 0.03 molL⁻¹ s⁻¹ as measured by RTFTIR using 11 mW/cm² on-sample intensity of a xenon arc lamp to cure NVP containing 1% by weight 2,2-dimethoxyphenylacetophenone (DMPA, Aldrich Chemical Company) as initiator at 25° C.

There are now described possible modes of action from whence the surprising utility may be derived for the objective of the present invention. It is postulated that the inefficient polymerization and slow cure rates of the hetero-atom containing (meth)acrylate compounds used in the radiation curable compositions of this invention, as observed in the described kinetic experiments, allows and causes consequential amounts of residual un-cured hetero-atom monomer to remain in the cured coatings, ink, and/or adhesives made from compositions containing the monomer(s). Upon subjection to high temperature and/or high pressure during the injection molding stage of the IMD process, the residual un-cured monomer may migrate to the interface of the cured ink, coating, and/or adhesive and the injected molten thermoplastic, as observed by detection of such monomers at the ink/injected polycarbonate interface of peeled IMD laminate articles. This migration may effect benefit for adhesion in several possible ways: 1) migration of the uncured monomer through the surface of the cured ink, coating, and/or adhesive may create pores in the ink surface which may be partially or completely filed by molten thermoplastic, allowing penetration of the polycarbonate into the coating layers resulting in entanglement and enhanced physical adhesion upon cooling of the thermoplastic, 2) uncured monomer at the interface may partially solvate and swell the surface layers of the ink, allowing interpenetration of solvated thermoplastic resin into the coating surface, again creating physical adhesion upon cooling of the thermoplastic, and/or 3) the uncured monomer at the interface may partially solvate the molten thermoplastic allowing better wetting of the ink surface by the molten thermoplastic and thereby enhancing adhesion in the cooled laminated article.

The hetero-atom functionality of the particular polymerizable monomer component in the compositions of the present invention very likely affords enhancements of postulated modes 2) and 3) above due to enhanced dilution and solvation effects due to hydrogen bonding, polar, and acid/base interactions. Similar kinetic data have been observed for N-vinylamide monomers (depicted in structures V and VI in Scheme 3), and similar modes of action are postulated to occur when examples of N-vinylamides are included in the radiation curable compositions. Particularly useful embodiments of the polymerizable monomer component include: (2-Oxo-1,3-dioxolan-4-yl)methyl methacrylate known as GMA carbonate, and N-vinylpyrrolidinone. Heterocyclic functional radiation curable monomers that showed very high rates of cure did not show the adhesion benefits in inks and coatings for IDM, as described in the previously detailed comparison.

Based upon these kinetic and applications data and the proposed modes of action of the invention, a range of rates of polymerization as measured by RTFTIR at 25° C. using 25 mW/cm² on-sample light intensity from the full arc of a medium pressure mercury lamp to cure 10 μm-thick samples containing 5% by weight Darocur 1173, in a salt crystal/polypropylene liminate is defined. Hetero-atom containing free-radically polymerizable monomers useful for significantly enhancing adhesion of radiation curable inks, coatings, tie-layers, and adhesives to the injected thermoplastic layer in IMD laminates will consist of compounds as defined by Structures I-IX wherein the selected compounds each exhibit a maximum rate of homopolymerization in the range 0.01-7 molL⁻¹ s⁻¹, and excluding those compounds defined by Structures I-IX that exhibit maximum rates of homopolymerization higher than the stated range under the stated measurement conditions. Compounds included within these limitations will exhibit slow or inefficient polymerization and/or copolymerization properties in the formulations as defined in the description such that the compounds remain in part or in whole unpolymerized in the cured inks, coatings, adhesive layers, etc., and thereby significantly enhancing adhesion in IMD and IMC laminates. More preferred is to use compounds of structures I to IX which have a maximum rate of homopolymerization of at most 4, most preferably of at most 2, molL⁻¹ s⁻¹. More preferred is to use compounds of structures I to IX which have a maximum rate of homopolymerization of at least 0.03, most preferably of at least 0.7, molL⁻¹ s⁻¹.

### EXAMPLES

General Process for Preparing and Printing an IMD Screen-Ink Formulation

1) Components employed in examples which follow included those selected from the following categories:
Oligomer—provides the chemical backbone of the ink and primarily determines the cured ink's flexibility, weatherability, durability, etc., and affects the ink's viscosity and adhesion
Monomer—used to increase cure speed, modify the viscosity of the ink, can increase or decrease the cured ink's flexibility, chemical resistance, scratch and abrasion resistance, and adhesion to the substrate
Adhesion promoters—used to enhance adhesion to difficult substrates including plastics: usually amine, amide, or urethane functional. Also affect cure-speed and pigment wetting and dispersion.
Pigments—provide color base for the ink; usually variation on five basic colors: cyan, magenta, yellow, white, black; used at about 5-50% by weight in the final ink
Defoamer and other additives—defoamer is added to reduce tendency of the ink to foam under shear conditions during ink making and printing; other additives such as surfactants, pigment dispersants, flow-aids are added to tune the quality and printing characteristics of the inks
Fillers—added to modify the scratch and abrasion resistance, increase or decrease gloss (shine), increase or decrease viscosity and ink flow, decrease cost of the ink; include aluminum oxide, silicas talc, etc.
Photoinitiator—initiates curing of the UV-ink on exposure to radiation

2) The components of the pre-mil ink formulation are mixed together including the oligomer, some of the monomer portion, pigment, defoamer, and some additives such as dispersing aid

3) The pre-mill formulation is run through a 3-roll mill that grinds the pigment particles into small dispersible pieces and disperses the pigment evenly into the oligomer/monomer pre-mill formulation to make a pigment dispersion.

4) The pigment dispersion is then diluted with additional monomer, and the final additives, filers, photoinitiator, etc. are added and evenly dispersed into the ink.

5) The ink is then diluted as appropriate to reach the desired viscosity for printing.

6) The final ink is screen-printed as follows
a) The ink is placed in a line on one side of the screen using an ink-knife.
b) The ink is then spread across the image area of the screen under pressure using a squeegee, and the strokes are repeated to get the desired ink thickness.
c) The printed substrate is then cured by passing under ultraviolet light on a conveyor belt.

7) Steps a-c are then repeated for as many additional colors as necessary, using different image screens as necessary.

Examples of Inks and Clear Coatings

General Process

Inks and/or clear coating compositions were prepared via typical methods known to those skilled in the art. The inks and coatings contained the following types of components: oligomers, monomers, photoinitiators, and additives. Definition of the components used in the examples are given below. Samples for injection molding and adhesion testing were printed by hand on 8.5×11″ Lexan® sheets using a Durometer A70 squeegee, a 355/34 pw mesh screen with 15-17N/cm tension, and 2-3 passes through a Fusion UV-Systems curing unit equipped with two 600-H bulbs at about 80-120 ft/m Samples for thermoforming testing were printed by hand on 14×14″ Lexan® sheets using a Durometer A70 squeegee, a 390/31 pw mesh screen, with 17-19N/cm tension, and two passes through a Fusion UV-Systems curing unit equipped with two 600-H bulbs at about 80 ft/min.

Oligomers

General Process for Synthesizing the Urethane Acrylate Oligomers:

Diisocyanate, catalyst, and stabilizer are charged to the reactor. The alkoxy acrylate is mixed with an inhibitor and the mixture is added slowly to a stirring solution in the reactor. The reactor mixture is then held at about 65° C. for about 1 hour. The preheated polyol or polyol mix is charged to the staring reactor mixture over about 1-2 hours, maintaining temperature less than about 93° C. The mixture is then stirred and held at about 88-93° C. until the reaction is complete. The product is then transferred from the reactor to storage containers and allowed to cool.

RX04916: about 7,500 g/mol urethane acrylate oligomer based upon 2-hydroxyethyl acrylate, isophorone diisocyanate, and hexanediol-adipate-isophthalate polyester. Elongation at break ˜320%.

RX04918: about 4,475 g/mol urethane acrylate oligomer based upon 2-[(1-oxo-2-propenyl)oxy]ethylester, isophorone diisocyanate, hexanediol-adipate-isophthalate polyester polyol, and hexandiolcarbonate. Elongation at break ˜230%.

RX04935: about 7,500 g/mol urethane acrylate oligomer based upon 2-hydroxyethyl acrylate, isophorone diisocyanate, and hexanediol-adipate-isophthalate polyester and diluted with 20% isobornylacrylate by weight Elongation at break ˜420%.

RX04939: about 8,700 g/mol urethane acrylate oligomer based upon 2-hydroxyethyl acrylate, isophorone diisocyanate, hexanediol-adipate-isophthalate polyester polyol, and poly(tetrahydrofuran) polyol and diluted with about 30% isobornylacrylate by weight. Elongation at break ˜550%.

RX04944: about 9,270 g/mol urethane acrylate oligomer based upon 2-hydroxyethyl acrylate, isophorone diisocyanate, hexanediol-adipate-isophthalate polyester polyol, and poly(tetrahydrofuran) polyol and diluted with about 27.5% isobornylacrylate by weight. Elongation at break ˜510%.

RX04945: about 9,850 g/mol urethane acrylate oligomer based upon 2-hydroxyethyl acrylate, isophorone diisocyanate, hexanediol-adipate-isophthalate polyester polyol, and poly(tetrahydrofuran) polyol and diluted with about 30% isobornylacrylate by weight. Elongation at break ˜550%.

RX04948: about 9,270 g/mol urethane acrylate oligomer based upon 2-hydroxyethyl acrylate, isophorone diisocyanate, hexanediol-adipate-isophthalate polyester polyol, and poly(tetrahydrofuran) polyol and diluted with about 27.5% isobornylacrylate by weight.

RX04952: about 7, 130 g/mol urethane acrylate oligomer based upon 2-hydroxyethyl acrylate, isophorone diisocyanate, and hexanediol-adipate-isophthalate polyester polyol and diluted with about 20% isobornylacrylate by weight

RX04957: about 9,920 g/mol urethane acrylate oligomer based upon 2-hydroxyethyl acrylate, isophorone diisocyanate, hexanediol-adipate-isophthalate polyester polyol, and poly(tetramethylene ether) polyol and diluted with about 30% isobornylacrylate by weight.

RX04959: about 8,090 g/mol urethane acrylate oligomer based upon 2-hydroxyethyl acrylate, isophorone diisocyanate, hexanediol-adipate-isophthalate polyester polyol, and poly(tetramethylene ether) polyol and diluted with about 24.5% isobornylacrylate by weight.

RX04960: about 7,780 g/mol urethane acrylate oligomer based upon 2-hydroxyethyl acrylate, isophorone diisocyanate, hexanediol-adipate-isophthalate polyester polyol, and poly(tetramethylene ether) polyol and diluted with about 23% isobornylacrylate by weight.

Ebecryl® 8411 (UCB Chemicals): aliphatic polyurethane acrylate.

IRR 381 (UCB Chemicals): 2,700 g/mol urethane acrylate oligomer.

Polymerizable Diluting Monomers

IBOA (UCB Chemicals) isobornyl acrylate.

IRX03593: experimental acrylate monomer.

Additives

Ebecryl® 7100 (UCB Chemicals): amine-functional acrylate monomer to promote adhesion

TEGO® Foamex N (Goldschmidt Chemical Corporation), used as defoamer Fluorinated Compatiblilizers

PolyFox™ TB (Omnova)

Zonyl® FSG (Dupont)

Zonyl® FSN (Dupont)

Fluorad™ FC-4430 (3 Corporation)

Polymerizable Monomer Components

RD RX/201: (2-Oxo-1,3-dioxolan-4-yl)methyl methacrylate, known as GMA carbonate

NVP: N-vinylpyrrolidinone.

### Example 1

A UV-polymerizable ink composition was prepared via the process outlined previously being composed of: 31.54 g RX04935 (polyester-based urethane acrylate), 15.14 g RX04945 (polyester/polyether urethane acrylate), 20.81 g BOA (UCB Chemicals), 8.88 g RD RX/201, 3.78 g NVP, 7.57 g Ebecryl® 7100 (UCB Chemicals), 0.50 g TEGO® Foamex N (Goldschmidt Chemical Corporation), 0.53 g Zonyl® FSG (Dupont), 1.89 g magenta pigment, and 9.34 g Viacure DX/LX photointiator blend (UCB Chemicals). The ink was printed on a Lexan® 8010 polycarbonate sheet by hand in two layers using Durometer A70 squeegee through a 355/34 pw mesh screen with 17-19N/cm tension, and cured in two passes through a Fusion UV Systems curing unit with two 600-H bulbs at about 80 ft/min. The ink showed excellent adhesion to the Lexan® substrate and was not tacky to touch. The ink was then tested for adhesion in IMD laminates. Results are given in Table 1.

Inks in five colors (cyan, magenta, yellow, black, white) were prepared based upon this oligomer/monomer/additive composition. Prints for thermoforming evaluation were made by hand on 14×14″ Lexan® sheets using a Durometer A70 squeegee, a 390/31 pw mesh screen with 15-17N/cm tension, and 2-3 passes through a Fusion UV-Systems curing unit equipped with two 600-H bulbs at about 80-120 ft/min. The inks in all colors showed excellent adhesion to the Lexan® substrate, little to no surface tack, and exhibited excellent thermoforming characteristics at draw ratios from 1:1 to 8:1.

### Example 2

A UV-polymerizable ink composition was prepared via the process outlined previously being composed of: 6.08 g RX04935 (polyester-based urethane acrylate), 43.24 g RX04944 (polyester/polyether based urethane acrylate), 18.72 g IBOA (UCB Chemicals), 16.22 g RD RX/201, 5.41 g Ebecryl® 7100 (UCB Chemicals), 0.54 g TEGO® Foamex N (Goldschmidt Chemical Corporation), 3.04 g magenta pigment, and 6.76 g Viacure DX/IX (UCB Chemicals). The ink was printed on a Lexan® 8010 polycarbonate sheet by hand in two layers using Durometer A70 squeegee through a 355/34 pw mesh screen with 17-19N/cm tension, and cured in 2-3 passes through a Fusion UV Systems curing unit with two 600-H bulbs at about 80-120 ft/min. The ink showed excellent adhesion to the Lexan® substrate and was not tacky to touch. The ink was then tested for adhesion in IMD laminates. Results are given in Table 1.

### Example 3

A TV-polymerizable clear-coat composition was prepared via the process outlined previously being composed of: 24.18 g RX04918 (polyester/polycarbonate based urethane acrylate), 11.38 IRR 381 (polyester based urethane acrylate), 32.72 g RX03593, 22.76 g RD RX/201, 4.27 g Ebecryl® 7100 (UCB Chemicals), 0.43 g TEGO® Foamex N (Goldschmidt Chemical Corporation), and 4.27 g Darocur® 1173 (Ciba® Specialty Chemicals). The clear coat was printed in two layers on-top of a standard magenta ink which was composed of: 63.91 g Ebecryl® 8411, 5.46 g IBOA (UCB Chemicals), 13 g NVP, 5 g Ebecryl® 7100 (UCB Chemicals), 0.18 g TEGO® Foamex N (Goldschmidt Chemical Corporation), 4.46 g magenta pigment, and 8 g Viacure DX/LX. The ink was printed on a Lexan® 8010 polycarbonate sheet by hand in two layers using Durometer A70 squeegee through a 355/34 pw mesh screen with 17-19N/cm tension, and cured in 2-3 passes through a Fusion UV Systems curing unit with two 600-H bulbs at about 80-120 ft/min. The clear coat was then printed in two layers on top of the ink following the same procedure. The print showed excellent adhesion to the Lexan® substrate and was slightly tacky to touch. The clear-coated ink was then tested for adhesion in IMD laminates. Results are given in Table 1.

### Example 4

A UV-polymerizable ink composition was prepared via the process outlined previously being composed of: 40 g RX04935 (polyester-based urethane acrylate), 29.2 g IBOA (UCB Chemicals), 11.6 g RD RX/201, 2.8 g Ebecryl® 7100 (UCB Chemicals), 0.4 g TEGO® Foamex N (Goldschmidt Chemical Corporation), 4 g magenta pigment, 10 g Viacure DX/IX, and 2 g Darocur® 1173 (Ciba® Specialty Chemicals). The ink was printed on a Lexan® 8010 polycarbonate sheet by hand in two layers using Durometer A70 squeegee through a 355/34 pw mesh screen with 17-19N/cm tension, and cured in 2-3 passes through a Fusion UV Systems curing unit with two 600-H bulbs at about 80-120 ft/min. The ink showed excellent adhesion to the Lexan® substrate and was slightly tacky to touch. The ink was then tested for adhesion in IMD laminates. Results are given in Table 1.

### Example 5

A UV-polymerizable ink composition was prepared via the process outlined previously being composed of: 23.87 g RX04935 (polyester-based urethane acrylate), 19.89 g RX04939 (polyester/polyether urethane acrylate), 21.88 g IBOA (UCB Chemicals), 13.26 g RD X/201, 3.98 g NVP, 6.63 g Ebecryl® 7100 (UCB Chemicals), 0.53 g TEGO® Foamex N (Goldschmidt Chemical Corporation, 1.33 g TS-100 (Degussa), 1.99 g magenta pigment, and 6.63 g Viacure DX/LX photoinitiator blend. The ink was printed on a Lexan® 8010 polycarbonate sheet by hand in two layers using Durometer A70 squeegee through a 355/34 pw mesh screen with 17-19N/cm tension, and cured in two passes through a Fusion UV Systems curing unit with two 600-H bulbs at about 80 ft/min. The ink showed excellent adhesion to the Lexan® substrate and was not tacky to touch. The ink was then tested for adhesion in IMD laminates. Results are given in Table 1.

Inks in five colors (cyan, magenta, yellow, black, white) were prepared based upon this oligomer/monomer/additive composition. Prints for thermoforming evaluation were made by hand on 14×14″ Lexan® sheets using a Durometer A70 squeegee, a 390/31 pw mesh screen with 15-17N/cm tension, and 2-3 passes through a Fusion UV-Systems curing unit equipped with two 600-H bulbs at about 80-120 ft/min. The inks in all colors showed excellent adhesion to the Lexan® substrate, little to no surface tack, and exhibited excellent thermoforming characteristics at draw ratios from 1:1 to 8:1.

### Example 6

A UV-polymerizable clear-coat composition was prepared via the process outlined previously being composed of: 40.76 g RX04918 (polyester/polycarbonate based urethane acrylate), 19.88 g RX03593. 24.85 g RD RX/201, 4.97 g NVP, 4.97 g Ebecryl® 7100 (UCB Chemicals), 0.60 g TEGO® Foamex N (Goldschmidt Chemical Corporation), and 3.98 g Darocur® 1173 (Ciba® Specialty Chemicals). The clear coat was printed in two layers on-top of a standard magenta ink which was composed of: 63.91 g Ebecryl® 8411, 5.46 g IBOA (UCB Chemicals), 13 g NVP, 5 g Ebecryl® 7100 (UCB Chemicals), 0.18 g TEGO® Foamex N (Goldschmidt Chemical Corporation), 4.46 g magenta pigment, and 8 g Viacure DX/IX. The ink was printed on a Lexan® 8010 polycarbonate sheet by hand in two layers using Durometer A70 squeegee through a 355/34 pw mesh screen with 17-19N/cm tension, and cured in 2-3 passes through a Fusion UV Systems curing unit with two 600-H bulbs at about 80-120 ft/min. The clear coat was then printed in two layers on top of the ink following the same procedure. The print showed excellent adhesion to the Lexan® substrate and was slightly tacky to touch. The clear-coated ink, was then tested for adhesion in IMD laminates. Results are given in Table 1.

### Example 7

A UV-polymerizable ink composition was prepared via the process outlined previously being composed of: 45.90 g RX04959 (polyester/polyether-based urethane acrylate), 15.23 g BOA (UCB Chemicals), 13.87 g RD RX/201, 4.17 g NVP, 7.29 g Ebecryl® 7100 (UCB Chemicals), 0.52 g TEGO® Foamex N (Goldschmidt Chemical Corporation), 0.52 g TS-100 (Degussa), 4.17 g magenta pigment, and 8.33 g Viacure DX/IX photoinitiator blend. The ink was printed on a Lexan® 8010 polycarbonate sheet by hand in two layers using Durometer A70 squeegee through a 355/34 pw mesh screen with 17-19N/cm tension, and cured in two passes through a Fusion UV Systems curing unit with two 600-H bulbs at about 80 ft/min. The ink showed excellent adhesion to the Lexan® substrate and was not tacky to touch. The ink was then tested for adhesion in DM laminates. Results are given in Table 1.

Inks in five colors (cyan, magenta, yellow, black, white) were prepared based upon this oligomer/monomer/additive composition. Prints for thermoforming evaluation were made by hand on 14×14″ Lexan® sheets using a Durometer A70 squeegee, a 390/31 pw mesh screen with 15-17N/cm tension, and 2-3 passes through a Fusion UV-Systems curing unit equipped with two 600-H bulbs at about 80-120 ft/min The inks in all colors showed excellent adhesion to the Lexan® substrate, little to no surface tack, and exhibited excellent thermoforming characteristics at draw ratios from 1:1 to 8:1.

### Example 8

A LTV-polymerizable ink composition was prepared via the process outlined previously being composed of: 47.69 g 1=4960 (polyester/polyether-based urethane acrylate), 18.13 g IBOA (UCB Chemicals), 9.08 g RD RX/201, 4.08 g NVP, 8.16 g Ebecryl® 7100 (UCB Chemicals), 0.51 g TEGO® Foamex N (Goldschmidt Chemical Corporation), 0.1 g Fluorad™ FC-4430 (3M™), 4.08 g magenta pigment, and 8.16 g Viacure DX/IX photoinitiator blend. The ink was printed on a Lexan® 8010 polycarbonate sheet by hand in two layers using Durometer A70 squeegee through a 355/34 pw mesh screen with 17-19N/cm tension, and cured in two passes through a Fusion UV Systems curing unit with two 600-H bulbs at about 80 ft/min. The ink showed excellent adhesion to the Lexan® substrate and was not tacky to touch. The ink was then tested for adhesion in IMD laminates. Results are given in Table 1.

Inks in five colors (cyan, magenta, yellow, black, white) were prepared based upon this oligomer/monomer/additive composition Prints for thermoforming evaluation were made by hand on 14×14″ Lexan® an sheets using a Durometer A70 squeegee, a 390/31 pw mesh screen with 15-17N/cm tension, and 2-3 passes through a Fusion UV-Systems curing unit equipped with two 600-H bulbs at about 80-120 ft/min. The inks in all colors showed excellent adhesion to the Lexan® substrate, little to no surface tack, and exhibited excellent thermoforming characteristics at draw ratios from 1:1 to 8:1.

### Example 9

A UV-polymerizable clear-coat composition was prepared via the process outlined previously being composed of: 40.76 g RX04918 (polyester/polycarbonate based urethane acrylate), 24.85 g RX03593, 24.85 g RD RX/201, 4.97 g Ebecryl® 7100 (UCB Chemicals), 0.60 g TEGO® Foamex N (Goldschmidt Chemical Corporation), and 3.98 g Darocur® 1173 (Ciba® Specialty Chemicals). The clear coat was printed in two layers on-top of a standard magenta ink which was composed of, 63.91 g Ebecryl® 8411, 5.46 g IBOA (UCB Chemicals), 13 g NVP, 5 g Ebecryl® 7100 (UCB Chemicals), 0.18 g TEGO®D Foamex N (Goldschmidt Chemical Corporation), 4.46 g magenta, pigment, and 8 g Viacure DX/LX. The ink was printed on a Lexan® 8010 polycarbonate sheet by hand in two layers using Durometer A70 squeegee through a 355/34 pw mesh screen with 17-19N/cm tension, and cured in 2-3 passes through a Fusion UV Systems curing unit with two 600-H bulbs at about 80-120 ft/min. The clear coat was then printed in two layers on top of the ink following the same procedure. The print showed excellent adhesion to the Lexan® substrate and was slightly tacky to touch. The clear-coated ink was then tested for adhesion in MAD laminates. Results are given in Table 1.

### Example 10

A UV-polymerizable ink composition was prepared via the process outlined previously being composed of: 44.06 g RX04959 (polyester/polyether-based urethane acrylate), 18.62 g IBOA (UCB Chemicals), 13.32 g RD RX/201, 4 g NVP, 7 g Ebecryl® 7100 (UCB Chemicals), 0.4 g TEGO® Foamex N (Goldschmidt Chemical Corporation), 0.2 g FluoradT FC-4430 (3M™), 4 g magenta pigment, and 8 g Vlacure DLX/photoinitiator blend. The ink was printed on a Lexan® 8010 polycarbonate sheet by hand in two layers using Durometer A70 squeegee through a 355/34 pw mesh screen with 17-19N/cm tension, and cured in two passes through a Fusion UV Systems curing unit with two 600-H bulbs at about 80 ft/min. The ink showed excellent adhesion to the Lexan® substrate and was not tacky to touch. The ink was then tested for adhesion in IMD laminates. Results are given in Table 1.

### Example 11

A UV-polymerizable ink composition was prepared via the process outlined previously being composed of: 40.80 g RX04952 (polyester-based urethane acrylate), 26.80 g IBOA (UCB Chemicals), 11.80 g RD RX/201, 6 g Ebecryl® 7100 (UCB Chemicals), 0.4 g TEGO® Foamex N (Goldschmidt Chemical Corporation), 4 g magenta pigment, and 10.2 g Viacure DX/IX photoinitiator blend. The ink was printed on a Lexan® 8010 polycarbonate sheet by hand in two layers using Durometer A70 squeegee through a 355/34 pw mesh screen with 17-19N/cm tension, and cured in two passes through a Fusion UV Systems curing unit with two 600-H bulbs at about 80 ft/min. The ink showed excellent adhesion to the Lexan® substrate and was not tacky to touch. The ink was then tested for adhesion in MD laminates. Results are given in Table 1.

### Example 12

A UV-polymerizable clear-coat composition was prepared via the process outlined previously being composed of: 30.92 g RX04918 (polyester/polycarbonate based urethane acrylate), 9.45 IRR 381 (polyester based urethane acrylate), 24.73 g IBOA (UCB Chemicals), 5.30 g RX03593, 17.67 g RD) RX/201, 3.53 g NVP, 4.42 g Ebecryl® 7100 (UCB Chemicals), 0.44 g TEGO® Foamex N (Goldschmidt Chemical Corporation), and 3.53 g Darocur® 1173 (Ciba® Specialty Chemicals). The clear coat was printed in two layers on-top of a standard magenta ink which was composed of: 63.91 g Ebecryl® 8411, 5.46 g IBOA (UCB Chemicals), 13 g NVP, 5 g Ebecryl® 7100 (UCB Chemicals), 0.18 g TEGO® Foamex N (Goldschmidt Chemical Corporation), 4.46 g magenta pigment, and 8 g Viacure DX/LX. The ink was printed on a Lexan® 8010 polycarbonate sheet by hand in two layers using Durometer A70 squeegee through a 355/34 pw mesh screen with 17-19N/cm tension, and cured in 2-3 passes through a Fusion UV Systems curing unit with two 600-H bulbs at about 80-120 ft/min. The clear coat was then printed in two layers on top of the ink following the same procedure. The print showed excellent adhesion to the Lexan® substrate and was somewhat tacky to touch. The clear-coated ink was then tested for adhesion in IMD laminates. Results are given in Table 1.

### Example 13

A UV-polymerizable ink composition was prepared via the process outlined previously being composed of: 31.60 g RX04935 (polyester-based urethane acrylate), 15.17 g RX04945 (polyester/polyether urethane acrylate), 20.85 g IBOA (UCB Chemicals), 8.90 g RD RX/201, 3.79 g NVP, 7.58 g Ebecryl® 7100 (UCB Chemicals), 0.51 g TEGO® Foamex N (Goldschmidt Chemical Corporation), 0.36 g Fluorad™ FC-4430 (3M™), 1.90 g magenta pigment, and 9.36 g Viacure DX/IX photoinitiator blend. The ink was printed on a Lexan® 8010 polycarbonate sheet by hand in two layers using Durometer A70 squeegee through a 355/34 pw mesh screen with 17-19N/cm tension, and cured in two passes through a Fusion UV Systems curing unit with two 600-H bulbs at about 80 ft/min. The ink showed excellent adhesion to the Lexan® substrate and was not tacky to touch. The ink was tested for adhesion in DM laminates. Results are given in Table 1.

Inks in five colors (cyan, magenta, yellow, black white) were prepared based upon this oligomer/monomer/additive composition. Prints for thermoforming evaluation were made by hand on 14×14″ Lexan® sheets using a Durometer A70 squeegee, a 390/31 pw mesh screen with 15-17N/cm tension, and 2-3 passes through a Fusion UV-Systems curing unit equipped with two 600-H bulbs at about 80-120 ft/min. The inks in all colors showed excellent adhesion to the Lexan® substrate, little to no surface tack, and exhibited excellent thermoforming characteristics at draw ratios from 1:1 to 8:1.

### Example 14

A UV-polymerizable clear-coat composition was prepared via the process outlined previously being composed of: 42.91 g RX04916 (polyester-based urethane acrylate), 22.44 g IBOA (UCB Chemicals), 22.44 g RD RX/201, 3.59 g NVP, 4.49 g Ebecryl® 7100 (UCB Chemicals), 0.54 g TEGO® Foamex N (Goldschmidt Chemical Corporation), and 3.59 g Darocur® 1173 (Ciba® Specialty Chemicals). The clear coat was printed in two layers on-top of a standard magenta ink which was composed of: 63.91 g Ebecryl® 8411, 5.46 g IBOA (UCB Chemicals), 13 g NVP, 5 g Ebecryl® 7100 (UCB Chemicals), 0.18 g TEGO® Foamex N (Goldschmidt Chemical Corporation), 4.46 g magenta pigment, and 8 g Viacure DX/IX. The ink was printed on a Lexan® 8010 polycarbonate sheet by hand in two layers using Durometer A70 squeegee through a 355/34 pw mesh screen with 17-19N/cm tension, and cured in 2-3 passes through a Fusion UV Systems curing unit with two 600-H bulbs at about 80-120 ft/min. The clear coat was then printed in two layers on top of the ink following the same procedure. The print showed excellent adhesion to the Lexan® substrate and was not tacky to touch. The clear-coated ink was then tested for adhesion in IMD laminates. Results are given in Table 1.

### Example 15

A UV-polymerizable ink composition was prepared via the process outlined previously being composed of: 23.90 g RX04952 (polyester-based urethane acrylate), 19.90 g RX04957 (polyester/polyether-based urethane acrylate), 10.20 g IBOA (UCB Chemicals), 25 g RD RX/201, 4 g NVP, 6.60 g Ebecryl® 7100 (UCB Chemicals), 0.5 g TEGO® Foamex N (Goldschmidt Chemical Corporation), 2 g magenta pigment, and 6.6 g Viacure DX/LX photoinitiator blend. The ink was printed on a Lexan® 8010 polycarbonate sheet by hand in two layers using Durometer A70 squeegee through a 355/34 pw mesh screen with 17-19N/cm tension, and cured in two passes through a Fusion UV Systems curing unit with two 600-H bulbs at about 80 ft/min. The ink showed excellent adhesion to the Lexan® substrate and was not tacky to touch. The ink was then tested for adhesion in IMD laminates. Results are given in Table 1.

TABLE 1
Results from adhesion testing to various IMD
injection-molded polycarbonate substrates.

| | Lexan ® SP 1010 | Lexan ® SP 1010R |
|---|---|---|
| Example 1 | Not tested | Good adhesion |
| Example 2 | Not tested | Good adhesion |
| Example 3 | Some adhesion | Not tested |
| Example 4 | Not tested | Good adhesion |
| Example 5 | Not tested | Good adhesion |
| Example 6 | Some adhesion | Not tested |
| Example 7 | Not tested | Good adhesion |
| Example 8 | Not tested | Good adhesion |
| Example 9 | Some adhesion | Not tested |
| Example 10 | Not tested | Good adhesion |
| Example 11 | Not tested | Some adhesion |
| Example 12 | Some adhesion | Not tested |
| Example 13 | Not tested | Good adhesion |
| Example 14 | Good adhesion | Not tested |
| Example 15 | Not tested | Good adhesion |

### Example 16

A UV-polymerizable ink composition was prepared via the process outlined previously being composed of: 43.03 g RX04948 (polyester/polyether-based urethane acrylate), 34.97 g IBOA (UCB Chemicals), 2 g NVP, 7 g Ebecryl® 7100 (UCB Chemicals), 0.7 g TEGO® Foamex N (Goldschmidt Chemical Corporation), 0.3 g TEGO® RAD 2250 (Goldschmidt Chemical Corporation), 1.5 g silica, 4.5 g magenta pigment, and 6 g Viacure DX. The ink was printed by hand in two layers using Durometer A70 squeegee through a 355/34 pw mesh screen with 17-19N/cm tension, and cured in two passes through a Fusion UV Systems curing unit with two 600-H bulbs at 85 ft/min. The ink showed excellent adhesion and good thermoforming characteristics on the following substrates: polystyrene, Lexan® SP 8010 polycarbonate, polyethylene terephthalate-G of two thicknesses: 4 mm and 500 microns, polyethylene terephthalate, and rigid PVC without any surface treatment.

Surface tack and blocking characteristics of the Ink were tested by making a stack composed of one 1.5×1.5″ sample of each of the printed substrates stacked front to back. A cover sheet of polycarbonate and a 1 kg weight was placed on top of the stack with the force applied to the face of the printed samples. The stack was then placed at 25° C. at 48% relative humidity for 24 hours and the evaluated for tack and sticking. This test was then repeated at 35, 45, 55, and 65° C. None of the samples showed any increase in surface tack or tendency to stick to or transfer to the bottom of the substrate above it.

### Example 17

A UV-polymerizable ink composition was prepared via the process outlined previously being composed of: 43.73 g RX04948 (polyester/polyether-based urethane acrylate), 34.77 g IBOA (UCB Chemicals), 2 g NVP, 7 g Ebecryl® 7100 (UCB Chemicals), 0.7 g TEGO® Foamex N (Goldschmidt Chemical Corporation), 0.3 g TEGO® RAD 2250 (Goldschmidt Chemical Corporation), 1.5 g silica, 4 g cyan pigment, and 6 g Viacure DX. The ink was printed by hand in two layers using Durometer A70 squeegee through a 355/34 pw mesh screen with 17-19N/cm tension, and cured in two passes through a Fusion UV Systems curing unit with two 600-H bulbs at 85 ft/min The ink showed excellent adhesion and good thermoforming characteristics on the following substrates: polystyrene. Lexan® SP 8010 polycarbonate, polyethylene terephthalate-G of two thicknesses: 4 mm and 500 microns, polyethylene terephthalate, and rigid PVC without any surface treatment. The cured ink was not tacky to touch.

### Example 18

A UV-polymerizable ink composition was prepared via the process outlined previously being composed of: 43.73 g RX04948 (polyester/polyether-based urethane acrylate), 34.27 g IBOA (UCB Chemicals), 2 g NVP, 7 g Ebecryl® 7100 (UCB Chemicals), 0.7 g TEGO® Foamex N (Goldschmidt Chemical Corporation), 0.3 g TEGO® RAD 2250 (Goldschmidt Chemical Corporation), 1 g silica, 5 g yellow pigment, and 6 g Viacure DX. The ink was printed by hand in two layers using Durometer A70 squeegee through a 355/34 pw mesh screen with 17-19N/cm tension, and cured in two passes through a Fusion UV Systems curing unit with two 600-H bulbs at 85 ft/min. The ink showed excellent adhesion and good thermoforming characteristics on the following substrates: polystyrene. Lexan® SP 8010 polycarbonate, polyethylene terephthalate-G of two thicknesses: 4 mm and 500 microns, polyethylene terephthalate, and rigid PVC without any surface treatment. The cured ink was not tacky to touch.

### Example 19

A UV-polymerizable ink composition was prepared via the process outlined previously being composed of: 43.03 g RX04948 (polyester/polyether-based urethane acrylate), 35.47 g IBOA (UCB Chemicals), 2 g NVP, 7 g Ebecryl® 7100 (UCB Chemicals), 0.7 g TEGO® Foamex N (Goldschmidt Chemical Corporation), 0.3 g TEGO® RAD 2250 (Goldschmidt Chemical Corporation), 1.5 g silica, 4 g black pigment, and 6 g Viacure DX The ink was printed by hand in two layers using Durometer A70 squeegee through a 355/34 pw mesh screen with 17-19N/cm tension, and cured in two passes through a Fusion UV Systems curing unit with two 600-H bulbs at 85 ft/min. The ink showed excellent adhesion and good thermoforming characteristics on the following substrates: polystyrene, Lexan® SP 8010 polycarbonate, polyethylene terephthalate-G of two thicknesses: 4 mm and 500 microns, polyethylene terephthalate, and rigid PVC without any surface treatment. The cured ink was not tacky to touch.

### Example 20

A UV-polymerizable ink composition was prepared via the process outlined previously being composed of: 26.81 g RX04948 (polyester/polyether-based urethane acrylate), 21.19 g IBOA (UCB Chemicals), 2 g NVP, 7 g Ebecryl® 7100 (UCB Chemicals), 0.7 g TEGO® Foamex N (Goldschmidt Chemical Corporation), 0.3 g TEGO® RAD 2250 (Goldschmidt Chemical Corporation), 36 g white pigment, and 6 g Viacure LX. The ink was printed by hand in two layers using Durometer A70 squeegee through a 355/34 pw mesh screen with 17-19N/cm tension, and cured in two passes through a Fusion UV Systems curing unit with two 600-H bulbs at 85 ft/mL The ink showed excellent adhesion and good thermoforming characteristics on the following substrates: polystyrene, Lexan® SP 8010 polycarbonate, polyethylene terephthalate-G of two thicknesses: 4 mm and 500 microns, polyethylene terephthalate, and rigid PVC without any surface treatment. The cured ink was not tacky to touch.

1. A polymerizable coating composition comprising:
a) about 5-85% by weight of a urethane (meth)acrylate oligomer as depicted below, or a mixture of such oligomers, wherein the polymerizable oligomer or oligomer mixture shows percent elongation at break greater tan about 100% and a number average molecular weight of about 1,000-20.000 g/mol, said oligomer having the formula:
CH₂═CH(R1)-COO—R2-OCONH—R3-NHCOO—[Z-OCONH—R3-NHCO]ₙ—O—R2-OCO—CH(R1)=CH₂
where:
R1=H, CH₃
R2=CH_{2 CH}₂, CH₂CH(CH₃)CH₂, CH₂CH₂O[CO(CH₂)₅)_{q}, CH₂CH₂CH₂CH₂, CH₂CHCH₃, CH₂CH₂CH₂, CH₂CH₂CH₂CH₂CH₂
n=1 to about 20
q=1 to about 20
R3=aliphatic, cycloaliphatic, heterocyclic, or aromatic radical with molecular weight about 25-10.000 g/mol
Z=moiety from one or more of: polyesters, polyethers, polyglycols, polycarbonates, polyurethanes, polyolefins; having a number average molecular weight of about 25-10,000 g/mol, wherein said Z moieties have the following formulae:
polyesters: -[A-OCO—B—COO]ₘ-A- or —[E-COO]ₘ-D-[OCO-E]ₘ-
polyethers/polyglycols: -A-[G-O]ₘ-G- or -G-[O-G]ₘ-O-A-O-[G-O]ₘ-G- or -A-
polycarbonates: -J-[OCOO-J]ₘ-
polyurethanes: -L-[OCON-Q-NCOO-L]ₘ-
polyolefins: -Q-[R]ₘ-Q-
where:
A=linear, branched, or cyclic aliphatic or aromatic radical with a molecular weight of about 14 g/mol-1,000 g/mol based upon C and H, and optionally containing, N, O, S, or Si
B=linear, branched, or cyclic aliphatic or aromatic radical with a molecular weight of about 14 g/mol-1,000 g/mol based upon C and H, and optionally containing N, O, S, or Si
D=linear, branched, or cyclic aliphatic or aromatic radical with a molecular weight of about 14 g/mol-1,000 g/mol based upon C and H, and optionally containing N, O, S, or Si
E=linear, branched, or cyclic aliphatic or aromatic radical with a molecular weight of about 14 g/mol-1,000 g/mol based upon C and H, and optionally containing N, O, S, or Si
G=linear, branched, or cyclic aliphatic radical with a molecular weight of about 14 g/mol-1,000 g/mol based upon C and H, and optionally containing N, O, S, or Si
J=linear, branched, or cyclic aliphatic or aromatic radical with a molecular weight of about 14 g/mol-2,000 g/mol based upon C and H, and optionally containing N, O, S, or Si
L=linear, branched, or cyclic aliphatic or aromatic radical with a molecular weight of about 14 g/mol-2,000 g/mol based upon C and H, and optionally containing N, O, S, or Si
Q=linear, branched, or cyclic aliphatic or aromatic radical with a molecular weight of about 14 g/mol-2,000 g/mol based upon C and H, and optionally containing N, O, S, or Si
R=linear, branched, or cyclic aliphatic or aromatic radical with a molecular weight of about 14 g/mol-4,000 g/mol based upon C and H, and optionally containing N, O, S, or Si
m=1 to about 1,000, and
b. about 0.1-50% by weight of a polymerizable diluting monomer or mixture thereof selected from the group consisting of: (meth)acrylate, (meth)acrylamide, vinylether, vinylester, N-vinylamide, propenylether, maleimide, maleate, or fumarate, and
c. about 0.1-50% by weight of additional polymerizable oligomer, and
d. about 0-20% by weight of a compound or mixture of such compounds which may generate radicals capable of initiating the curing reactions of the curable composition and which may be activated by one or more methods selected from the group consisting of exposure to actinic radiation, exposure to Ionizing radiation, exposure to heat, and
e. about 0-25% by weight of other additives selected from the group consisting of amines, defoamers, flow aids, fillers, surfactants, acrylic polymers and copolymers, and adhesion promoters, and
f. about 0-5% by weight of a fluorinated compatibilizer, and
g. about 0.5-60% by weight of a polymerizable monomer component composed of one or more compounds selected from formulae I-IX, wherein the compound exhibit a maximum rate of homopolymerization within the range 0.01-7 moIL⁻¹ s⁻¹, as measured by RTFTIR at 25° C. using 25 mW/cm² on-sample light intensity from the full arc of a medium pressure mercury lamp to cure 10 μm-thick samples containing 5% by weight Darocur 1173 as photoinitiator, in a salt crystal/polypropylene laminate, such that the selected compounds will exhibit slow or inefficient polymerization and/or copolymerization properties such that the selected compounds remain in part or in whole unpolymerized in the cured coating, 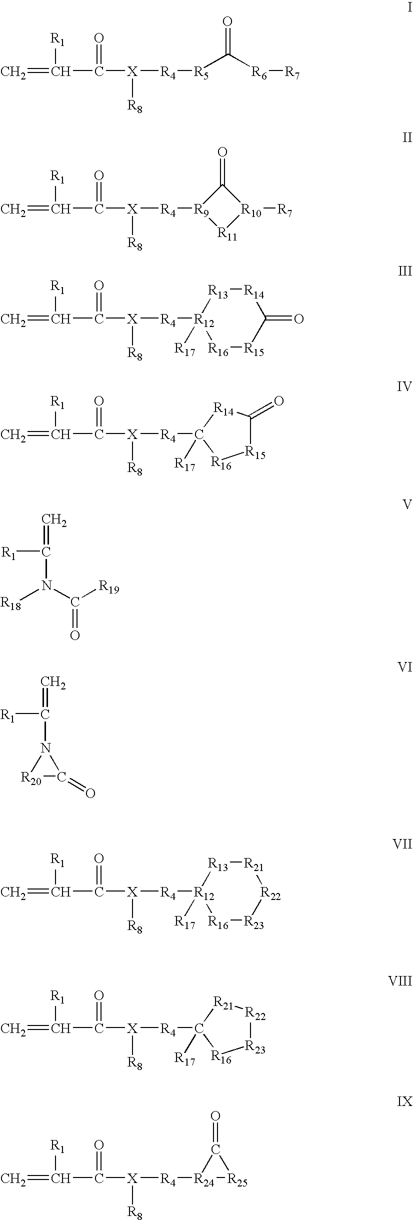
where:
R1=H, CH₃
X═O, N
R4=aliphatic or aromatic radical of about 15-1000 g/mol molecular weight containing C, H, and optionally one or more of N, O, S, Si
R5=O, N, S
R6=O, N, S
R7=H, or aliphatic or aromatic radical of about 15-1000 g/mol molecular weight containing C, H, and optionally one or more of N, O, O, Si
R8=absent when X=O; H, or aliphatic or aromatic radical of about 15-1000 g/mol molecular weight containing C, H, and optionally one or more of N, O, S, Si when X═N
R9=N
R10=N
R11=aliphatic or aromatic radical of about 15-1000 g/mol molecular weight containing C. H, and optionally one or more of N, O, S, Si
R12=O, N
R13=aliphatic radical having about 1-10 carbon atoms optionally containing N, O, or S
R14=O, NH, S
R15=O, NH, S
R16=aliphatic radical having about 1-10 carbon atoms optionally containing N, O, or S
R17=H, or aliphatic or aromatic radial of about 15-1000 g/mol molecular weight containing C, H, and optionally one or more of N, O, S, Si
R18=H, or aliphatic or aromatic radical with molecular weight about 15-1,000 g/mol
R19=H, or aliphatic or aromatic radical with molecular weight about 15-1,000 g/mol
R20=branched or straight-chained aliphatic, aromatic, or heterocyclic radical with molecular weight of about 14-1,000 g/mol.
R21=O, S, NR17
R22=CHR17
R23=O, S, NR17
R24=N
R25=aliphatic radical having about 1-10 carbon atoms optionally containing N, O, or S.

2. Ink compositions comprising compositions of claim 1.

3. Adhesive compositions comprising compositions of claim 1.

4. Multi-layer prints, laminates, adhesives, and other coated or printed, molded or unmolded, assemblies and articles containing as an intermediate layer a coating, ink, or adhesive produced from the compositions of claim 1.

5. Articles and assemblies of claim 4 of the following types: polymer/polymer laminates, polymer/glass laminates, thermoformed laminate objects, in-mold decorated objects, in-mold coated objects, mirrors, photopolymer printing plates.

6. A process for IMD and IMC which comprises coating and/or printing coating, ink, or adhesive compositions of claim 1 onto a polymeric substrate, optionally thermoforming said coated and/or printed substrate, followed by injection molding said substrate to produce an IMD or IMC article or assembly.
